(19) United States
(12) Patent Application Publication
(10) Pub. No.: US 2026/0295472 A1
(43) Pub. Date: Oct. 1, 2026

(54) SYSTEM FOR CLEANING EQUIPMENT INTENDED TO BE PLACED IN A SOLID/LIQUID SEPARATION SETTLER, AND ASSOCIATED INSTALLATION AND METHOD

(71) Applicant: SUEZ INTERNATIONAL, Puteaux (FR)

(72) Inventors: Quentin MARIOT, PARIS LA DEFENSE CEDEX (FR); Philippe DECLERCK, PARIS LA DEFENSE CEDEX (FR)

(21) Appl. No.: 19/477,613

(22) PCT Filed: Apr. 26, 2024
(86) PCT No.: PCT/EP2024/061525

§ 371 Date: Oct. 22, 2025

(30) Foreign Application Priority Data
Apr. 27, 2023 (FR) FR2304261

(51) Int. Cl. B01D 21/00; B01D 21/06; B01D 21/20; B01D 21/24

(52) U.S. Cl. CPC B01D 21/0006; B01D 21/0051; B01D 21/06; B01D 21/20; B01D 21/2405

(57) ABSTRACT

The system (14) includes:

a cleaning boom (54), defining an internal cleaning fluid circulation passage (74) that opens out via at least one ejection orifice (76);

a drive shaft (50) for rotating the cleaning boom (54), extending vertically between a lower end (60) and an upper end (62), the drive shaft (50) internally defining an internal cleaning fluid circulation channel (66) fluidically connected to the internal passage (74);

a system (56) for rotating the drive shaft (50) about the axis of rotation (A-A′).

The internal cleaning fluid circulation channel (66) is configured to be supplied with cleaning fluid through the lower end (60) of the drive shaft (50).

The present invention relates to a cleaning system for equipment intended to be placed in a solid/liquid separation settler, the cleaning system including:
a cleaning boom, defining an internal passage for the circulation of a cleaning fluid opening through at least one cleaning fluid ejection orifice;
a rotary drive shaft for rotating the cleaning boom extending vertically between a lower end and an upper end, the drive shaft being rotatably mounted around a vertical axis of rotation, the cleaning boom protruding laterally relative to the axis of rotation, the drive shaft internally defining an internal channel for the circulation of cleaning fluid fluidically connected to the internal passage of the cleaning boom;
a system for rotating the drive shaft around the axis of rotation.

The cleaning device is intended in particular to be placed in a settlement structure performing a liquid/solid separation to treat water, particularly wastewater, industrial water, or drinking water.

Some settlement structures include settlers equipped with lamellar modules, for example, formed of honeycomb structures. These modules are arranged in a settlement basin, above the point where the water to be treated is introduced.

The lamellar modules contribute to the solid-liquid separation by capturing at least part of the solids to allow them to settle, while the clarified liquids can rise through the lamellar module.

Settlers thus equipped with lamellar modules are effective in terms of separation, which can reduce the space occupied by the water treatment installation for a given treatment flow. However, they require periodic maintenance to prevent clogging.

The cleaning of lamellar modules is often carried out manually by an operator from outside the structure, notably by high-pressure water projection.

Alternatively, EP 0 958 849 describes an automated system including a pressurized air declogging boom, provided on the underside of the lamellar modules.

The use of a declogging boom increases the time between two manual cleaning operations by an operator and thus helps reduce operating costs.

Other types of lamellar settlers are equipped with a cleaning device including one or more scraper arms driven in rotation by a shaft. The cleaning device is equipped with a rotary drive head composed of a drive crown and a gear motor offset relative to the crown.

It is then known to equip the device with at least one declogging boom that is driven in rotation together with the scraping arms.

To supply the boom with air, the cleaning device includes an overhead air inlet that passes through the rotary drive crown of the cleaning device shaft.

A rotary joint connects the fixed overhead piping to a second rotary piping placed in the drive shaft and hydraulically connected to the cleaning boom.

The cleaning boom has calibrated orifices that release pressurized air towards the upper part of the settler. This air dislodges solids (particularly sludge) attached to the lamellae of the lamellar module. The rotation of the shaft exposes the entire lamellar surface to the pressurized air flow ejected by the boom.

Such a cleaning device is therefore particularly effective. However, it can still be improved.

In particular, the manufacture of the rotary drive head requires precise machining involving special tooling to create the frame wherein the crown rests, and the pinion that connects the gear motor to the crown. The manufacturing cost of such a system is therefore high.

Furthermore, during the use of the drive system, the crown is immersed in several tens of liters of oil that must be maintained at level.

The rotary joint is also a wear part and a source of air leaks, as it is composed of bearings. It must be replaced periodically, for example, every 4 to 5 years.

This results in significant operating costs, which could be reduced.

An object of the invention is therefore to provide a cleaning device allowing frequent and effective cleaning of a settler, particularly equipped with lamellar modules, the cleaning device being simpler to manufacture and less costly to operate.

To this end, the invention relates to a cleaning device of the aforementioned type, characterized in that the internal channel for the circulation of cleaning fluid is configured to be supplied with cleaning fluid through the lower end of the drive shaft.

The cleaning device according to the invention may comprise one or more of the following features, taken alone or in any technically possible combination:
the cleaning system comprises an internal supply line for the internal channel in cleaning fluid, fixed in rotation during the rotation of the drive shaft, the internal line extending vertically through the drive shaft;
the internal line protrudes downward beyond the lower end of the drive shaft, the cleaning system including at least one closure piece of the intermediate space defined between the internal line and the drive shaft positioned at the lower end of the drive shaft;
the internal line extends to an upper end, and opens at its upper end or near its upper end;
the point at which the internal line opens is located at a height of at least 250 mm, notably at least 400 mm, above a tapping point of the internal passage in the internal channel for the circulation of cleaning fluid;
the internal line is provided at its upper end with a rotation guide piece of the drive shaft protruding radially towards the drive shaft, the rotation guide piece defining at least one axial through passage for the circulation of cleaning fluid;
the drive shaft and the internal line define between them an intermediate space, the internal passage of the cleaning boom opening in view of the intermediate space;
the drive shaft includes a cover, particularly a full flange, closing the intermediate space upwards;
the rotation drive system includes a gear motor group arranged in the axis of rotation of the drive shaft above its upper end, the gear motor group being advantageously configured to directly drive the drive shaft without additional reduction ratio;
the cleaning system includes at least one scraping arm carried by the drive shaft and protruding laterally relative to the drive shaft, the cleaning boom being advantageously arranged at a higher position than the scraping arm, preferably above and in view of the scraping arm;
the cleaning fluid is chosen from water or air.

The invention also relates to a settlement installation, including:
a solid/liquid separation settler comprising at least one basin with a bottom;
a cleaning system as defined above, mounted in the basin, the settlement installation comprising a cleaning fluid supply line opening at the bottom of the basin, the supply line being fluidically connected to the internal channel of the drive shaft through the lower end of the drive shaft.

The installation according to the invention may comprise one or more of the following features, taken alone or in any technically possible combination:
the equipment includes at least one lamellar module including a plurality of lamellae and/or hollow tubular elements disposed above the cleaning boom;
the settler includes a bridge crossing the basin, the bridge supporting the rotation drive system of the drive shaft.

The invention also relates to a cleaning method for a settlement installation as defined above, the method including the following steps:
activation of the rotation drive system of the drive shaft to rotate the drive shaft around its axis of rotation;
supply of the internal channel of the drive shaft with cleaning fluid through the lower end of the drive shaft;
circulation of the cleaning fluid from the internal channel of the drive shaft through the internal passage of the cleaning boom, and ejection of the cleaning fluid out of the cleaning boom into the basin through the or each ejection orifice.

The invention will be better understood by reading the following description, given solely by way of example, and made with reference to the appended drawings, wherein:

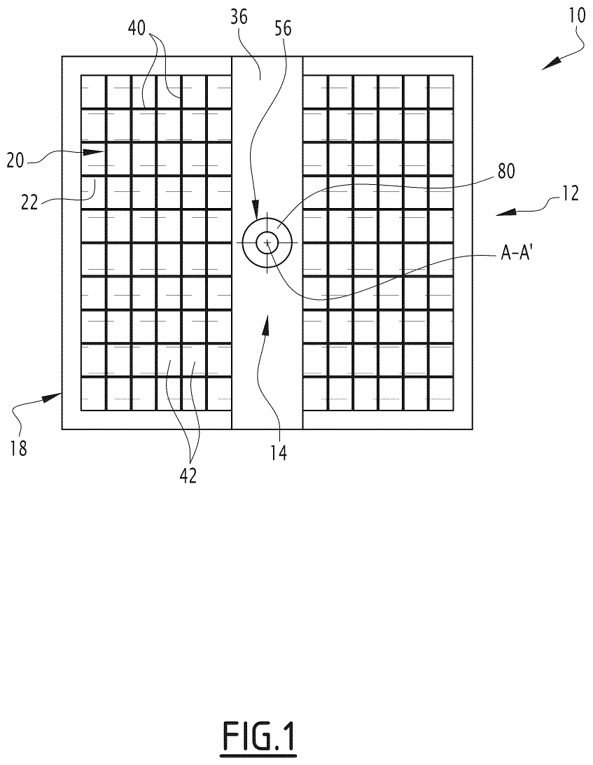

FIG. 1 is a schematic top view of a settler of a settlement installation, equipped with a cleaning system according to the invention;

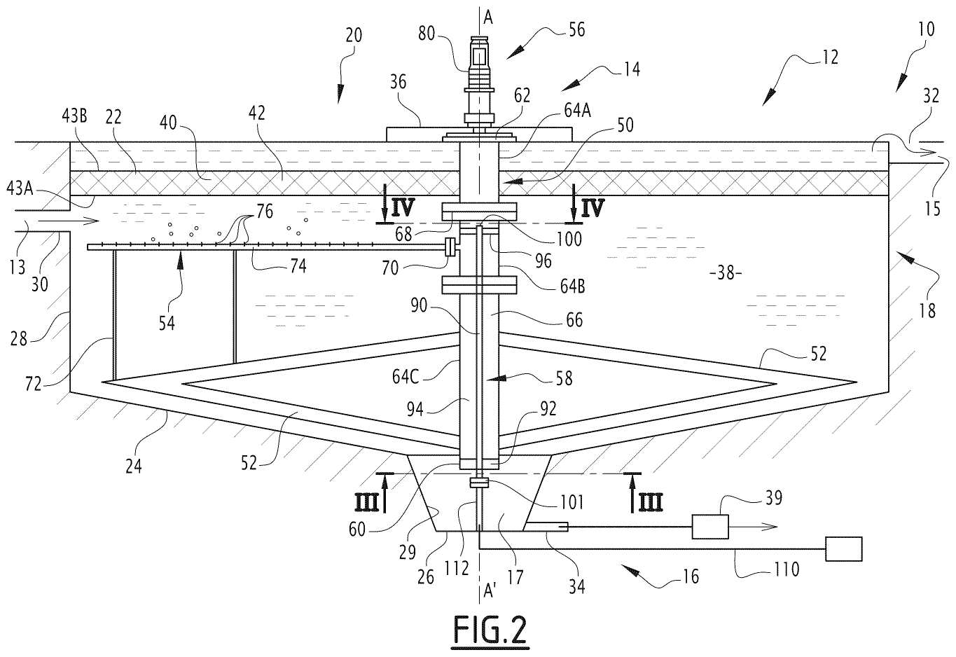

FIG. 2 is a schematic partial sectional view of the settler shown in FIG. 1;

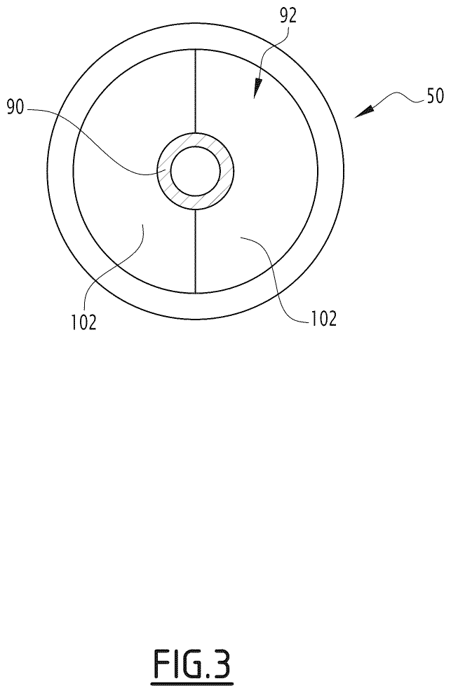

FIG. 3 is a bottom view of the drive shaft of the cleaning system according to the invention, taken along plane III of FIG. 2;

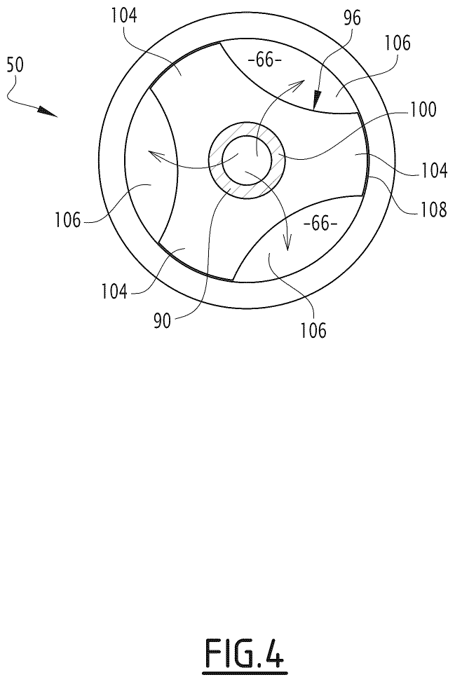

FIG. 4 is a partial sectional view of the drive shaft of the cleaning system according to the invention, taken along plane IV of FIG. 2.

A first settlement installation 10 according to the invention is schematically illustrated by FIGS. 1 to 4.

The installation 10 is intended to be placed in a water treatment unit to receive wastewater, industrial water, or drinking water for treatment to obtain clarified water.

Referring to FIGS. 1 and 2, the installation 10 includes a settler 12, suitable for receiving water to be clarified 13, containing solids, notably suspended matter, and liquids, to separate it into clarified water 15 with a reduced solids content and sedimented solids 17, particularly sludge, intended to be treated.

The installation 10 further includes a rotary cleaning system 14 of the settler 12, and a cleaning fluid supply assembly 16 to the cleaning system 14, visible in FIG. 2.

Referring to FIGS. 1 and 2, the settler 12 includes at least one basin 18 receiving the water to be clarified 13, and a separation equipment 20 mounted in the basin 18, the equipment 20 including in this example at least one lamellar module 22.

The basin 18 is advantageously rectangular in shape and has a central axis A-A′. It includes side walls 28, a bottom inclined 24 towards its center, and a sludge collection pocket 26, located at the lowest point of the bottom 24.

The basin 18 further includes at least one inlet 30 for water to be clarified 13, at least one outlet 32 for clarified water 15, and at least one outlet 34 for sedimented solids 17.

The bottom 24 here includes at least one inclined slope from the side wall 28 towards the pocket 26. The inclination angle of the bottom 24 relative to a horizontal plane is, for example, between 15° and 30°.

The side walls 28 are vertical here. The side walls 28 and the bottom 24 define an interior volume 38 for separating the water to be clarified 13, which opens upwards into the atmosphere.

The volume 38 also opens downwards into the pocket 26, to collect the sedimented solids.

The interior volume 38 is, for example, greater than 30 m³ and is notably between 20 m³ and 2500m³.

The inlet 30 for water to be clarified 13 opens laterally into a side wall 28. It is preferably located below the separation equipment 20, notably below the lamellar modules 22.

The outlet 32 for clarified water 15 is located above the separation equipment 20, notably above the lamellar modules 22, notably at the surface of the basin 18,

It advantageously extends opposite the inlet 30 for water to be clarified 13 relative to the axis A-A′. It includes, for example, an overflow outlet above the side wall 28 of the basin 18.

The pocket 26 opens upwards at the lowest point of the bottom 24. It defines a collection volume for sedimented solids. It is delimited by a lateral surface 29 having an inclination angle relative to a horizontal plane greater than the inclination angle of the inclined slopes of the bottom 24 relative to the same horizontal plane.

The outlet 34 for sedimented solids 17 opens at the bottom of the pocket 26. It is connected to a pump 39 for evacuating the sedimented solids, for treatment.

The equipment 20 is arranged in the interior volume 38 of the basin 18, near the surface of the basin 18. It includes at least one lamellar module 22, for example, several lamellar modules 22 advantageously covering a horizontal section of the interior volume 38 around the cleaning system 14.

Each lamellar module 22 is formed of a plurality of lamellae 40, preferably inclined relative to the vertical, which define between them through passages 42 from a lower surface 43A of the module 22 to an upper surface 43B of the module 22.

Alternatively, the lamellar module 22 is formed of a plurality of tubular elements opening downwards into the lower surface 43A of the module 22 and upwards into the upper surface 43B of the module 22.

The internal passages 42 defined within the lamellar module thus constitute an obstacle for the solid elements contained in the water to be clarified 13. These are therefore preferentially retained below the lamellar module 22. Conversely, the clarified water 15 is able to rise and pass through the lamellar module 22.

Thus, the concentration of solids retained below the lamellar module 22 is able to increase, causing sedimentation of the solids towards the bottom 24 of the basin 18.

As illustrated in FIG. 2, the cleaning system 14 includes a rotary drive shaft 50, mounted vertically in the basin 18, and at least one scraping arm 52, protruding radially from the rotary drive shaft 50.

The cleaning system 16 further includes at least one cleaning boom 54 of the equipment 20, protruding radially relative to the rotary drive shaft 50 advantageously above and in view of a scraping arm 54, and a rotation drive system 56 of the rotary drive shaft 50.

According to the invention, the cleaning system 16 further includes a cleaning fluid supply system 58 through a lower end 60 of the hollow drive shaft 50.

The rotary drive shaft 50 extends vertically along its axis of rotation (which is here the central axis A-A′ of the basin 18), between the lower end 60 and an upper end 62, connected to the rotation drive system 56.

In this example, the rotary drive shaft 50 is formed of several segments 64A, 64B, 64C assembled end to end along the axis A-A′. Alternatively, the rotary drive shaft 50 is made in one piece in a single segment.

The rotary drive shaft 50 defines a central channel 66 for the circulation of cleaning fluid that extends at least between the lower end 60 and an inlet of the cleaning boom 54.

The circulation channel 66 extends here above the cleaning boom 54, up to a cover 68 formed of a full flange between two successive sections 64A, 64B of the rotary drive shaft 50.

The rotary drive shaft 50 is rotatably mounted around its axis A-A′ being driven in rotation by the rotation drive system 56. It jointly drives the or each cleaning boom 54, and the or each scraping arm 52 in rotation.

Each scraping arm 52 protrudes radially from an outer surface of the rotary drive shaft 50. It extends radially away from the rotary drive shaft 50 in view of the bottom 24. It includes scraping elements (not shown), for example, scraping blades, configured to scrape the sedimented solids on the bottom 24 and drive them towards the pocket 26.

The cleaning boom 54 also protrudes radially from the outer surface of the rotary drive shaft 50. It is, for example, mounted on a radial flange 70 present on the outer surface of the rotary drive shaft 50.

Preferably, the cleaning boom 54 extends horizontally above a scraping arm 52, and is connected to the scraping arm 52 by members 72.

The cleaning boom 54 defines an internal passage 74 for the circulation of cleaning fluid, fluidically connected to the circulation channel 66 and at least one ejection orifice 76 for cleaning fluid, preferably a plurality of ejection orifices 76 for cleaning fluid distributed along its length.

The cleaning boom 54 is here formed of a hollow tube extending perpendicularly to the axis A-A′ and internally defining the internal passage 74.

The internal passage 74 opens radially into the internal circulation channel 76 through the flange 70.

The orifices 76 are preferably oriented upwards to extend in view of the lower surface 43A. The linear density of orifices 76 is, for example, greater than 5 orifices per meter.

The area of each orifice 76 is, for example, greater than 2 mm² and is notably between 2 mm² and 10 mm², for example, 4 mm².

Thus, the cleaning fluid is able to circulate along the internal passage 74, and be ejected through the orifices 76 to rise towards the lower surface 43A of the equipment 20.

The rotation drive system 56 includes a gear motor group 80 coupled in rotation with the rotary drive shaft 50.

The gear motor group 80 is carried by the bridge 36. It extends here coaxially with the axis of rotation A-A′ of the rotary drive shaft 50. It directly drives the rotary drive shaft 50 in rotation. This drive is carried out by direct torque transmission from the gear motor group 80, without being reduced by an additional reduction ratio linked to a drive crown. The rotation drive system 56 is thus free of an oil bath.

The rotary drive shaft 50 is driven at a speed generally between 0.03 revolutions per minute and 0.5 revolutions per minute.

The cleaning fluid supply system 58 includes a vertical internal line 90, fixedly mounted in the circulation channel 66 of the rotary drive shaft 50, through the lower end 60 of the rotary drive shaft 50.

The cleaning fluid supply system 58 includes a closure piece 92 of the intermediate space 94 defined between the internal line 90 and the rotary drive shaft 50, and advantageously, a rotation guide piece 96 of the rotary drive shaft 50.

The internal line 90 preferably extends along the axis of rotation A-A′. It protrudes downward beyond the lower end 60 of the rotary drive shaft 50, for its connection to the supply assembly 16.

It extends continuously to an upper end 100 arranged above the cleaning boom 54.

Thus, the internal line 90 is connected at its lower end 101 to the supply assembly 16 below the lower end 60 of the rotary drive shaft 50. It opens at its upper end 100 above the tapping point of the internal passage 74 of the cleaning boom 54, and above the rotation guide piece 96.

Advantageously, the point at which the internal line 90 opens (here the upper end 100) is located at a height (taken along the axis A-A′) greater than at least 250 mm, notably at least 400 mm, above the tapping point of the internal passage 74, for example, 500 mm above the tapping point of the internal passage 74.

In the example shown in FIG. 2, the height of the internal line 90, taken from the lower end 60 of the rotary drive shaft 50 to the upper end 100 is greater than 30% of the height of the rotary drive shaft 50, taken between its lower end 60 and its upper end 62. This height is preferably between 30% and 50% of the height of the rotary drive shaft 50.

The closure piece 92 is visible in FIG. 3, in a bottom view. It closes downwards the intermediate space 94 defined between the internal line 90 and the rotary drive shaft 50 within the internal channel 66. It is here formed by a plurality of shells 102, for example, by two half-shells 102 extending around the internal line 90 to the internal surface of the rotary drive shaft 50.

Referring to FIG. 4, the rotation guide piece 96 is mounted near the upper end 100 of the internal line 90. It has a plurality of guide fingers 104, defining between them at least one through passage 106 for axial circulation of the cleaning fluid.

In this example, the number of circulation passages 106 is equal to the number of fingers 104. The number of fingers is, for example, greater than two, and is notably between two and five, for example, three in the example of FIG. 4.

Each finger 104 has an outer surface 108, complementary in shape to the internal surface of the rotary drive shaft 50 defining the internal channel 66.

Thus, the rotation of the rotary drive shaft 50 around its axis A-A′ is guided at the closure piece 92 by cooperation between the periphery of the shells 102 and the internal surface of the rotary drive shaft 50. It is guided at the upper end 100 of the internal line 90 by the fingers 104.

The cleaning fluid is preferably a gas, notably under pressure, at a pressure greater than 100 mbar and between 100 mbar and 1000 mbar. The gas is, for example, air.

The cleaning fluid is thus able to travel successively from bottom to top through the internal line 90 from its lower end 101 to the upper end 100, then to pass into the intermediate space 94 between the rotation guide piece 96 and the cover 68, before descending via the transverse passages 106 to the internal passage 74 of the cleaning boom to the cleaning fluid ejection orifices 76.

The supply assembly 16 includes at least one cleaning fluid supply line 110, arranged in the masonry at the foot of the basin 18. It comprises a vertical tapping 112, extending along the axis A-A′ in the pocket 26 for the connection of the lower end 101 of the internal line 90.

The operation of the settlement installation 10 will now be described.

Initially, water to be clarified 31 is advantageously continuously supplied into the interior volume 38 of the basin 18 through the inlet 13 for water to be clarified 31 located below the separation equipment 20.

As previously indicated, at least part of the solids contained in the water to be clarified 31, particularly suspended matter, are retained below the or each lamellar module 22 of the separation equipment 20. Conversely, the clarified water 15 rises through the internal passages 42 between the lamellae 40 and is continuously evacuated via the outlet 32 for clarified water 15.

The solids retained below the separation equipment settle and gradually deposit on the bottom 24.

The rotary drive shaft 50 is driven in rotation around the axis A-A′, intermittently or continuously, by activation of the gear motor group 80.

This causes the joint rotation of the or each scraping arm 52, which scrapes the sedimented solids deposited on the bottom 24 to drive them towards the pocket 26.

The pocket 26 collects the sedimented solids 17, which are evacuated intermittently or continuously through the evacuation outlet 34.

In some cases, solid residues accumulate on the lower surface 43A of the equipment 20, particularly at the entrance of the internal passages 42 defined between the lamellae 40, partially or totally blocking these passages 42.

To address this problem, cleaning fluid is supplied from the line 110 through the tapping 112, to the internal line 90.

The cleaning fluid successively travels upwards through the lower end 60 of the drive shaft 50 in the internal line 90 to the upper end 100 of the internal line 90, then passes into the intermediate space 94 between the rotation guide piece 96 and the cover 68, before descending via the transverse passages 106 to the internal passage 74 of the cleaning boom 54. It then circulates to the ejection orifices 76 for cleaning fluid.

The fluid ejected by the orifices 76, particularly in the form of gas bubbles, creates local turbulence under the lower surface 43A of each module 22 of the equipment 20, cleaning the lower surface 43A. Thus, the internal passages are unclogged and the settler 12 operates at maximum efficiency.

The or each cleaning boom 54 is driven in rotation around the axis A-A′ by the movement of the rotary drive shaft 50 around the same axis A-A′, produced by the gear motor group 80.

This rotation drive does not interfere with the injection of cleaning fluid to supply the cleaning boom 54. This injection is carried out according to the invention through the lower end 60 of the rotary drive shaft 50, without having to provide a rotary joint within the rotation drive system 56 or in the rotary drive shaft 50.

Indeed, the internal line 90 being fixed in rotation and opening within the circulation channel 66 present in the rotary drive shaft 50, the fluid injection is direct and directed towards the cleaning boom 54.

Furthermore, cleaning fluid remains permanently trapped in the circulation channel 66, which keeps the internal line 90 out of water. This prevents clogging of the internal line 90 by water to be clarified 13.

Moreover, the cleaning fluid is advantageously supplied by an underground network to supply the internal line 90 inserted in the rotary drive shaft 50, which limits the clutter of the installation 10 and simplifies utility networks.

All these measures greatly simplify the manufacture of the rotary drive shaft 50 and its rotation drive system 56, allowing it to completely dispense with the use of a drive crown and a rotary joint. No wear part is then present at the rotation drive of the rotary drive shaft 50, which limits the maintenance to be performed and reduces operating costs.

Furthermore, the design of the rotation drive system 56 is facilitated, thanks to the alignment of the rotation drive system 56 with the axis of rotation A-A′ of the rotary drive shaft 50.

In a variant (not shown), the rotary drive shaft 50 remains driven at its periphery by a gear motor. However, the injection of cleaning fluid is carried out by a cleaning fluid supply system 58 similar to that described above.

1-15. (canceled)

16. A cleaning system for equipment intended to be placed in a solid/liquid separation settler, the cleaning system including:
a cleaning boom, defining an internal passage for the circulation of a cleaning fluid opening through at least one ejection orifice for cleaning fluid;
a rotary drive shaft for rotating the cleaning boom, extending vertically between a lower end and an upper end, the drive shaft being rotatably mounted around a vertical axis of rotation, the cleaning boom protruding laterally relative to the axis of rotation, the drive shaft internally defining an internal cleaning fluid circulation channel fluidically connected to the internal passage of the cleaning boom;
a rotation drive system of the drive shaft around the axis of rotation;
wherein the internal cleaning fluid circulation channel is configured to be supplied with cleaning fluid through the lower end of the drive shaft.

17. The cleaning system according to claim 16, comprising an internal line for supplying the internal channel with cleaning fluid, fixed in rotation during the rotation of the drive shaft, the internal line extending vertically through the drive shaft.

18. The cleaning system according to claim 17, wherein the internal line protrudes downward beyond the lower end of the drive shaft, the cleaning system including at least one closure piece of the intermediate space defined between the internal line and the drive shaft positioned at the lower end of the drive shaft.

19. The cleaning system according to claim 17, wherein the internal line extends to an upper end, and opens at its upper end or near its upper end.

20. The cleaning system according to claim 19, wherein the point at which the internal line opens is located at a height greater than at least 250 mm, above a tapping point of the internal passage in the internal cleaning fluid circulation channel.

21. The cleaning system according to claim 17, wherein the internal line is provided at its upper end with a rotation guide piece of the drive shaft protruding radially towards the drive shaft, the rotation guide piece defining at least one axial through passage for the circulation of cleaning fluid.

22. The cleaning system according to claim 17, wherein the drive shaft and the internal line define between them an intermediate space, the internal passage of the cleaning boom opening in view of the intermediate space.

23. The cleaning system according to claim 22, wherein the drive shaft includes a cover, closing the intermediate space upwards.

24. The cleaning system according to claim 23, wherein the cover is a full flange.

25. The cleaning system according to claim 16, wherein the rotation drive system includes a gear motor group arranged in the axis of rotation of the drive shaft above its upper end.

26. The cleaning system according to claim 25, wherein the gear motor group is configured to directly drive the drive shaft without additional reduction ratio.

27. The cleaning system according to claim 16, including at least one scraping arm carried by the drive shaft and protruding laterally relative to the drive shaft.

28. The cleaning system according to claim 27, wherein the cleaning boom is arranged at a higher position than the scraping arm.

29. The cleaning system according to claim 27, wherein the cleaning boom is arranged above and facing the scraping arm.

30. The cleaning system according to claim 16, wherein the cleaning fluid is chosen from water or air.

31. A settlement installation, including:
a solid/liquid separation settler comprising at least one basin with a bottom;
a cleaning system according to claim 16, mounted in the basin, the settlement installation comprising a cleaning fluid supply line opening at the bottom of the basin, the supply line being fluidically connected to the internal channel of the drive shaft through the lower end of the drive shaft.

32. The settlement installation according to claim 31, wherein the equipment includes at least one lamellar module including a plurality of lamellae and/or hollow tubular elements arranged above the cleaning boom.

33. The settlement installation according to claim 31, wherein the settler includes a bridge crossing the basin, the bridge supporting the rotation drive system of the drive shaft.

34. A cleaning method for a settlement installation according to claim 31 including the following steps:
activation of the rotation drive system of the drive shaft to rotate the drive shaft around its axis of rotation;
supply of the internal channel of the drive shaft with cleaning fluid through the lower end of the drive shaft;
circulation of the cleaning fluid from the internal channel of the drive shaft through the internal passage of the cleaning boom, and ejection of the cleaning fluid out of the cleaning boom into the basin through the or each ejection orifice.
